(19) United States
(12) Patent Application Publication
(10) Pub. No.: US 2025/0045510 A1
(43) Pub. Date: Feb. 6, 2025

(54) METHOD, APPARATUS, ELECTRONIC DEVICE AND STORAGE MEDIUM FOR INFORMATION PROCESSING

(71) Applicant: Beijing Zitiao Network Technology Co., Ltd., Beijing (CN)

(72) Inventors: Siyu Hou, Beijing (CN); Linna Zhang, Beijing (CN); Zisheng Liu, Beijing (CN); Yao Wang, Beijing (CN)

(21) Appl. No.: 18/720,598

(22) PCT Filed: Dec. 7, 2022
(86) PCT No.: PCT/CN2022/137168

§ 371 Date: Jun. 14, 2024

(30) Foreign Application Priority Data
Dec. 15, 2021 (CN) 202111539381.7

(51) Int. Cl. G06F 40/166; G06F 40/197

(52) U.S. Cl. CPC G06F 40/166; G06F 40/197

(57) ABSTRACT

The disclosure provides a method, apparatus, electronic device and storage medium for information processing. The disclosure employs the following technical solutions. In some embodiments, the disclosure provides a method for information processing: creating a first document, displaying a workflow creation interface in response to receiving a first operation event in the first document; creating a workflow item associated with the first document in response to a second operation event for the workflow creation interface, wherein the workflow item has an associated processing personnel; displaying a workflow processing interface of the workflow item in the first document; wherein the workflow processing interface has a processing control for processing the workflow item. The embodiments of the disclosure improve the processing efficiency of the workflow item.

### CROSS-REFERENCE

The present application claims priority to Chinese Patent Application No. 202111539381.7, filed on Dec. 15, 2021, and entitled “METHOD, APPARATUS, ELECTRONIC DEVICE AND STORAGE MEDIUM FOR INFORMATION PROCESSING”, the entirety of which is incorporated herein by reference.

### FIELD

The present disclosure relates to the field of computer technology, and in particular, to a method, apparatus, electronic device and storage medium for information processing.

### BACKGROUND

In scenarios such as collaboration within a team or between teams, some items (such as approval items) need to be processed. When processing the items, the processing personnels need to fully understand the items with reference to some documents, and then process the items.

### SUMMARY

The present disclosure provides a method, device, electronic device and storage medium for information processing.

The present disclosure employs the following technical solutions.

In some embodiments, the present disclosure provides a method for information processing, comprising:
Creating a first document;
Displaying a workflow creation interface in response to receiving a first operation event in the first document;
Creating a workflow item associated with the first document in response to a second operation event for the workflow creation interface, wherein the workflow item has an associated processing personnel; and
Adding a workflow processing interface of the workflow item in the first document;
Wherein the workflow processing interface has a processing control for processing the workflow item.

In some embodiments, the present disclosure provides a apparatus for information processing, comprising:
A document creation unit for creating a first document;
A display unit for displaying a workflow creation interface in response to receiving a first operation event in the first document;
A workflow creation unit for creating a workflow item associated with the first document in response to a second operation event for the workflow creation interface, wherein the workflow item has an associated processing personnel; and
A control unit for adding a workflow processing interface of the workflow item in the first document;
Wherein the workflow processing interface has a processing control for processing the workflow item. In some embodiments, the present disclosure provides a electronic device, comprising: at least one memory and at least one processor;
Wherein the memory is used to store program code, and the processor is used to call the program code stored in the memory to perform the foregoing method.

In some embodiments, the present disclosure provides a computer-readable storage medium which is used to store program code, and when being executed by a processor, the program code causes the processor to perform the foregoing method.

In the information processing method provided by the embodiment of the present disclosure, after creating the workflow item associated with the first document, display the workflow processing interface of the workflow item in the first document. In this way, when processing the workflow item, the processing personnel can directly process the workflow item in the first document after viewing the first document without jumping from the first document to other interfaces, which reduces the operation of user jumping, facilitates user processing, and improves the processing efficiency of the workflow item.

### BRIEF DESCRIPTION OF THE DRAWINGS

The above and other features, advantages and aspects of various embodiments of the present disclosure will become more apparent with reference to the following detailed description in conjunction with the accompanying drawings. Throughout the accompanying drawings, the same or similar reference symbols refer to the same or similar elements. It should be understood that the accompanying drawings are schematic and that elements are not necessarily drawn to scale.

FIG. 1 is a flow chart of a method for information processing of embodiments of the present disclosure.

FIG. 2 is a displaying schematic diagram of the first document of embodiments of the present disclosure.

FIG. 3 is a displaying schematic diagram of the first document of embodiments of the present disclosure.

FIG. 4 is a displaying schematic diagram of the first document of embodiments of the present disclosure.

FIG. 5 is a displaying schematic diagram of the first document of embodiments of the present disclosure.

FIG. 6 is a displaying schematic diagram of the first document of embodiments of the present disclosure.

FIG. 7 is a displaying schematic diagram of the first document of embodiments of the present disclosure.

FIG. 8 is a displaying schematic diagram of the first document of embodiments of the present disclosure.

FIG. 9 is a displaying schematic diagram of workflow matters in the workflow application of embodiments of the present disclosure.

FIG. 10 is a displaying schematic diagram of the first document of embodiments of the present disclosure.

FIG. 11 is a displaying schematic diagram of the first document of embodiments of the present disclosure.

FIG. 12 is a flow chart of a method for information processing of embodiments of the present disclosure.

FIG. 13 is a schematic structural diagram of an electronic device of embodiments of the present disclosure.

### DETAILED DESCRIPTION

The embodiments of the present disclosure will be described in more detail below with reference to the accompanying drawings. Although some embodiments of the present disclosure are shown in the drawings, it would be appreciated that the present disclosure may be implemented in various forms and should not be interpreted as limited to the embodiments described herein. On the contrary, these embodiments are provided for a more thorough and complete understanding of the present disclosure. It would be appreciated that the drawings and embodiments of the present disclosure are only for the purpose of illustration and are not intended to limit the scope of protection of the present disclosure.

It would be appreciated that the steps described in the method embodiments of the present disclosure may be executed by pressing and/or in parallel. In addition, the method embodiments may include additional steps and/or omit the execution of the shown steps. The scope of the present disclosure is not limited in this regard.

As used herein, term “including” and similar terms would be appreciated as open inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions will be provided in the following.

It needs to be noted that concepts such as “first”, “second”, and the like mentioned in the present disclosure are only used to distinguish different apparatuses, modules or units, and are not used to limit the order or interdependence relationship of functions performed by these apparatuses, modules or units.

It needs to be noted that term “one” mentioned in the present disclosure is illustrative and not restrictive, and one skilled in the art should understand that this term should be understood as “one or more” unless the context clearly indicates otherwise.

The names of massages or information interacted among multiple apparatuses in the embodiments of the present disclosure are only for illustrative purpose, but not used to limit the scope of these messages or the information.

The solutions provided by the embodiments of the present disclosure will be described in detail below with reference to the accompanying drawings.

In scenarios such as collaboration within a team or between teams, some workflow items often occur, such as approval items. For example, the approval items may be contract approval, application approval, etc. When processing the workflow item, it is often necessary to refer to some documents, such as contracts or application documents, and return to the processing interface for processing the workflow item after consulting the documents, which requires the user to jump repeatedly between the document and the processing interface, causing user inconvenience and reducing the processing efficiency of the workflow item.

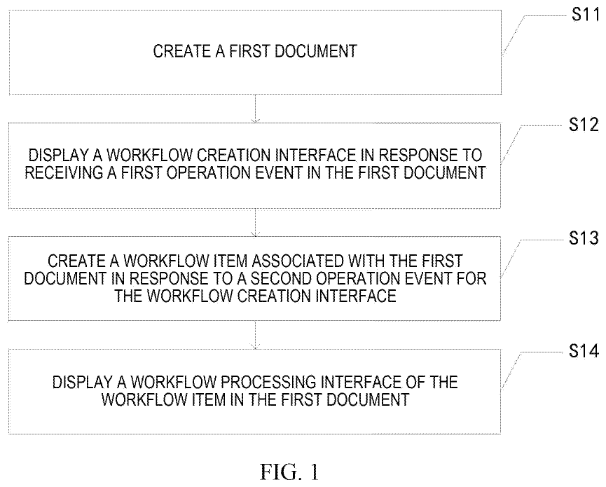

In some embodiments of the present disclosure, a method for information processing is proposed, as shown in FIG. 1. FIG. 1 is a flow chart of a method for information processing of embodiments of the present disclosure, comprising the following steps.

S11: create a first document.

In some embodiments, a performing party that performs the method of the present disclosure may be a terminal, a server, etc., and the first document may be an online document.

S12: display a workflow creation interface in response to receiving a first operation event in the first document.

In some embodiments, the first operation event may include one or more operations. The first operation event may be an operation event performed within the first document. The workflow creation interface is configured to create a workflow item. The workflow item may be, for example, an approval item. The workflow item may have an associated processing procedure. For example, create the workflow creation interface after an operation is performed for a workflow creation control.

S13: create a workflow item associated with the first document in response to a second operation event for the workflow creation interface.

In some embodiments, on the workflow creation interface, a workflow item may be created for the first document. For example, the workflow item may be an approval item for approving the first document. The first document may also be content that needs to be referenced during the processing of the workflow item. The second operation event may include one or more operation events. There is an associated processing personnel for the workflow item. In some embodiments, the workflow item is provided with a processing procedure. The processing procedure includes one or more processing nodes. There may be one or more processing personnels. The processing personnel is a person associated with a processing node. The processing personnels process respective associated processing nodes. The processing personnel processes the processing item in sequence according to the processing node of the processing item. For example, the workflow item may be an approval item, and the approval item may have one or more approval nodes. The approval node may be associated with an approver (processing personnel) who is responsible for approval according to the approval order. The first document may be an online document.

S14: display a workflow processing interface of the workflow item in the first document.

In some embodiments, the workflow processing interface has processing controls for processing the workflow item. In some embodiments, on the one hand, the workflow item may be created directly in the first document without performing additional operations outside the first document, which improves convenience. On the other hand, after creating the workflow item associated with the first document, display the workflow processing interface of the workflow item in the first document. In this way, when processing the workflow item, the processing personnel can directly process the workflow item in the first document after viewing the first document without jumping from the first document to other interfaces, which reduces the operation of user's jumping, facilitates user processing, and improves the processing efficiency of the workflow item.

In some embodiments of the present disclosure, displaying a workflow creation interface in response to receiving a first operation event in the first document comprises: displaying a component panel in response to a first operation for the first document, and displaying a workflow creation interface in response to a triggering operation for a first control in the component panel.

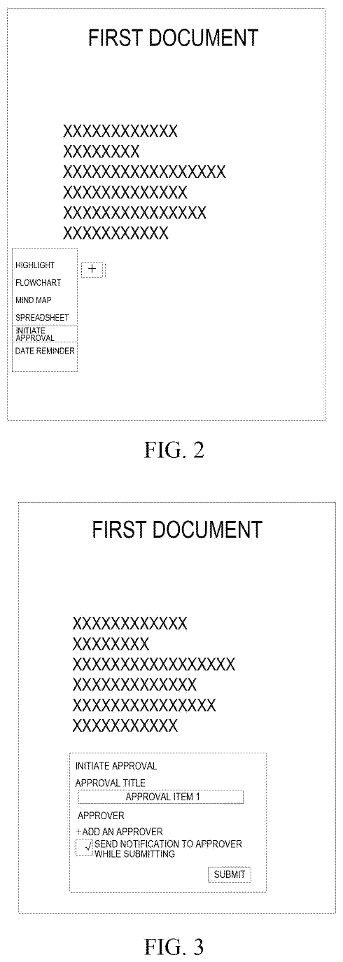

In some embodiments, the first operation event is performed in the first document to trigger the component panel. The first operation event may be a triggering operation on a certain control. One or more controls are displayed in the component panel, which may include the first control. The first control in the first document may be triggered to generate the workflow creation interface. Therefore, in the method of the embodiment of the present disclosure, the workflow item may be generated by directly performing operations in the first document without jumping to the outside of the first document. In some embodiments, with reference to FIG. 2, an internal control option button is displayed in the first document, for example, a block with a plus sign inside as shown in FIG. 2. After triggering the option button, optional controls are displayed. “Initiate Approval” shown in FIG. 2 is the first control. The first control is triggered by clicking or other methods. After the first control is triggered, as shown in FIG. 3, the workflow creation interface is displayed in the first document. The workflow creation interface in FIG. 3 is in the block where “initiate approval” is located. On the workflow creation interface, the title of the workflow item may be set, the processing personnel of the workflow item may be added, and an option that a notification may be sent to the processing personnel when the workflow item is submitted may be selected. In this embodiment, by providing the first control in the first document, the workflow item may be created directly in the first document without performing additional operations outside the first document, which simplifies the operations of the user and improves creation convenience for the workflow item.

In some embodiments of the present disclosure, creating a workflow item associated with the first document in response to a second operation event for the workflow creation interface comprises: determining a processing personnel of the workflow item in response to a second operation for a second control on the workflow creation interface; and creating a workflow item associated with the first document in response to a third operation for a third control on the workflow creation interface.

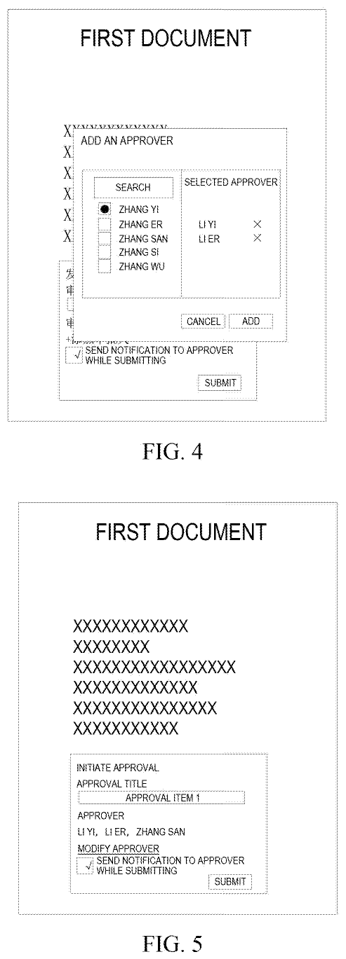

In some embodiments of the present disclosure, the workflow item has an associated processing personnel, and the processing personnel may be associated with a processing node of the workflow item, so as to process the workflow item according to the processing procedure of the workflow item. In some embodiments, with reference to FIG. 3, the workflow item may be an approval item. The second control is displayed on the workflow creation interface. The second control may be, for example, “Add an Approver” shown in FIG. 3. The second operation may include one or more operations. The second control may be triggered to display a processing personnel adding interface. As shown in FIG. 4, an area where “Add an Approver” displayed in FIG. 4 is located is the processing personnel adding interface. On the processing personnel adding interface, the processing personnel may be selected, and the processing personnel may also be searched. The processing personnel adding interface also displays processing personnels that have been added, by clicking “Add” in FIG. 4 to confirm the addition of the processing personnel. After adding the processing personnel, processing personnels “Li Yi, Li Er, and Zhang San” will be displayed on the workflow creation interface as shown in FIG. 5, and the style of the second control will change. As shown in FIG. 5, the characters displayed by the second control are changed to “Modify Approver”. The “Submit” button in FIG. 3 is the third control. The third button is triggered by clicking and other methods to transmit related parameters of the processing item to the system, such as the ID of the processing personnel, the name of the workflow item, and the like to complete the creation of the workflow item.

In some embodiments of the present disclosure, the third control is unavailable before determining a processing personnel of the workflow item, or the third control is hidden before determining a processing personnel of the workflow item. In some embodiments, the workflow item must have an associated processing personnel. In order to prevent submitting the workflow item without selecting a processing personnel, the third control (“Submit” in FIG. 3) button of the workflow creation interface will be unavailable before selecting the processing personnel. For example, it will be grayed out and cannot be clicked. Alternatively, the “Submit” button will not be displayed until the processing personnel is selected.

In some embodiments of the present disclosure, displaying a workflow creation interface in response to a first operation event comprises: determining a current location of a control identification in the first document in response to a first operation event; in response to that a document context exists at the current location, displaying the workflow creation interface below the current location; and in response to that no document content exists at the current location, displaying the workflow creation interface at the current location. In some embodiments of the present disclosure, the control identification may be an input cursor. When the workflow creation interface is displayed, the location of the current input cursor is first determined. If no document content exists at this location, the workflow creation interface will be directly inserted at this location. If content exists at the location, the workflow creation interface will be displayed in the next line of the location. In the embodiments of the present disclosure, the user himself can choose where to display the workflow creation interface. The advantage of this is, when processing a workflow item, the first document may be required to be referred to, the workflow creation interface can be directly displayed at partial content of the first document, so that the user can directly process the workflow item after viewing the content of the first document, which improves the processing efficiency and reduces the operation of user's flipping, and the processing personnel can be reminded of what should be focused on with the location of the workflow processing interface.

In some embodiments, displaying a workflow processing interface of the workflow item in the first document comprises: displaying the workflow processing interface at a location of the workflow creation interface after creating a workflow item associated with the first document, or displaying the workflow processing interface in an area corresponding to the workflow creation interface in a page of the first document after creating a workflow item associated with the first document. In some embodiments, the displaying workflow processing interface is displayed at a location of the workflow creation interface to replace the workflow creation interface with the workflow processing interface, or the workflow processing interface is displayed in a corresponding area of the workflow creation interface.

In some instances of the present disclosure, the workflow processing interface further displays at least one of the following: a name of the workflow item, a current processing status of the workflow item, an identification of a processing personnel of the workflow item, a processing result of the processing personnel, a control for adding the processing personnel, and an identification for jumping to the workflow item in a workflow application.

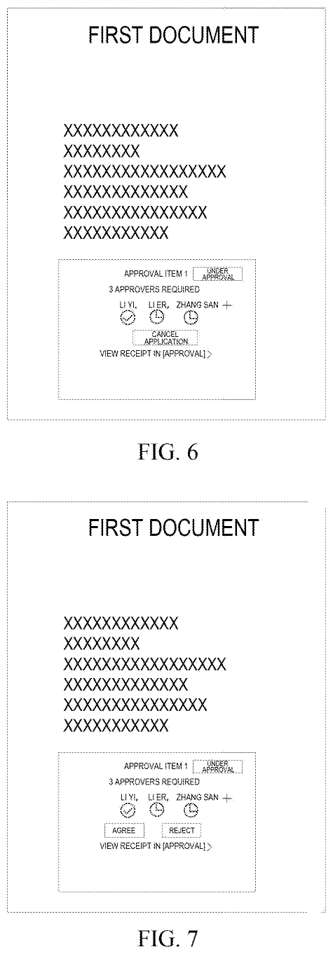

In some embodiments, with reference to FIG. 6, FIG. 6 schematically displays the workflow processing interface displayed in the first document opened by the creator of the workflow item. It can be seen that the workflow processing interface displays the title (name) of the workflow item and the current processing status of the workflow item. The current processing status is Under Approval, the identifications of the processing personnels are “Li Yi, Li Er, and Zhang San”, and symbols for identifying the processing results are displayed at the associated locations of the processing personnels' identifications. In FIG. 6, an icon with a check mark in the circle represents that the processing personnel has processed the workflow item, and an icon with a right angle in the circle indicates that the processing personnel has not yet processed the processing item. Therefore, in FIG. 6, Li Yi has already processed the processing item, while Li Er and Zhang San have not yet processed the processing item. A plus sign is displayed on the right side of the processing personnel's identification. This plus sign serves as a control for adding processing personnels. In this way, when the creator or processing personnel thinks that the processing item needs to be processed by other processing personnels, they can dynamically add processing personnels with this control. An identification for jumping to the workflow item in the workflow application is also displayed on the workflow processing interface. Specifically, the workflow application may be any application, such as an approval application. In the workflow application, a detailed form of the workflow item will be displayed. By triggering this identification, the processing personnel can jump to the workflow application to view the workflow item.

In some embodiments of the present disclosure, display a first preset flag at an identification of a processing personnel that has completed the workflow item. In some embodiments, display a second preset flag at an identification of a processing personnel that has not completed the workflow items. In FIG. 6, an icon with a check mark in the circle is the first preset flag, representing that the processing personnel has processed the workflow item; and an icon with a right angle in the circle is the second preset flag, representing that the processing personnel has not yet processed the processing item. Thus, in FIG. 6, Li Yi has already processed the processing item, while Li Er and Zhang Sand have not yet processed the processing item. With the first preset flag and the second preset flag, the user can directly view the processing results of the processing personnels for the workflow item on the workflow processing interface.

In some embodiments of the present disclosure, display the workflow processing interface when a person associated with the workflow item views the first document; or hide the workflow processing interface when a person not associated with the workflow item views the first document. Wherein the person associated with the workflow item comprises a creator and a processing personnel of the workflow item. In some embodiments, the first document may be viewed by a non-associated person, but the non-associated person is not a person who needs to process the first document. Therefore, in the case of the first document being opened by a non-associated person, the document processing interface is not displayed to avoid problems caused by mis-operations by the non-associated person.

In some embodiments of the present disclosure, a processing control displayed on the workflow processing interface is related to a role of a person viewing the first document. In some embodiments of the present disclosure, as shown in FIG. 6, FIG. 6 shows a schematic diagram of the workflow processing interface in the first document viewed by the creator after creating the workflow item, as shown in FIG. 7, FIG. 7 displays a schematic diagram of the workflow processing interface in the first document after the processing personnel viewing the first document. With reference to FIG. 6, in response to that a person viewing the first document is a creator of the workflow item, the processing control comprises: a control for undoing the workflow item (“Cancel Application” in FIG. 6). In some embodiments, the method further comprises: deleting the workflow processing interface in the first document in response to a triggering operation for a control for undoing the workflow item, in this way, the creator can cancel the workflow item according to need and delete the workflow processing interface thereof.

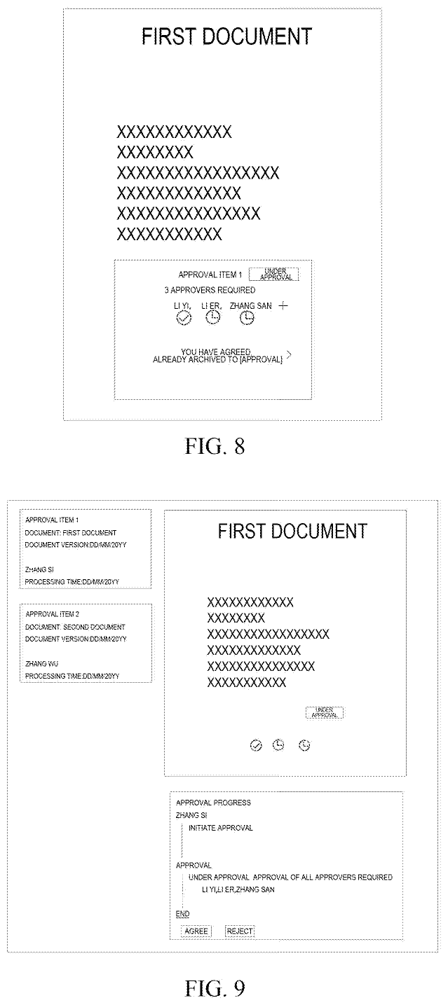

In some embodiments of the present disclosure, with reference to FIG. 7, in response to that a person viewing the first document is a processing personnel of the workflow item, the processing control comprises: a control for agreeing to the workflow item and a control for rejecting the workflow item (“Agree” and “Reject” in FIG. 7). In some embodiments, the processing controls are displayed on the workflow processing interface in the first document viewed by the workflow person only when the processing personnel has not yet processed the workflow item, and are no longer displayed after the processing personnel has processed the workflow item. For example, as shown in FIG. 8, which schematically displays a schematic diagram of the workflow processing interface after the processing personnel who has processed the workflow item opens the first document. It can be seen that the processing controls are no longer displayed on the workflow processing interface. As shown in FIG. 8, after the processing personnel agrees to the processing item, an identification of successful processing is displayed on the workflow processing interface and an archiving entrance is provided, and the first document processed can be opened with the archiving entrance. In some embodiments of the present disclosure, the method further comprises: in response to a triggering operation for a control for agreeing to the workflow item or a control for rejecting the workflow item, displaying a preset flag corresponding to a triggered control at an identification of a corresponding processing personnel on the workflow processing interface. In some embodiments, for a processing personnel who has completed the workflow item, the first preset flag is displayed at the processing personnel's identification, and for a processing personnel who has not completed the workflow item, the second preset flag is displayed at the processing personnel's identification.

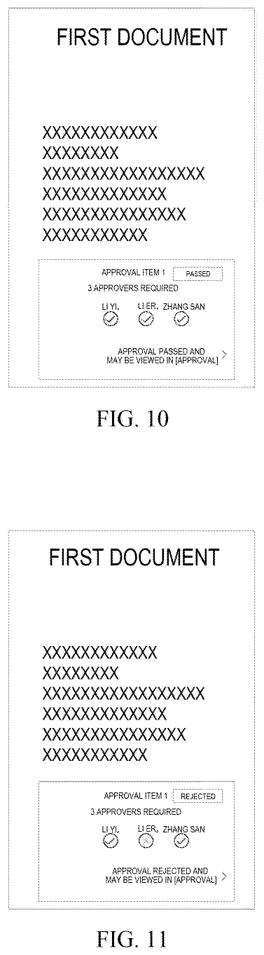

In some embodiments of the present disclosure, the method further comprises: in response to all processing personnels completing a triggering operation for a processing control, changing a current processing status of the workflow item on the workflow processing interface according to a processing result. In some embodiments, with reference to FIG. 10 and FIG. 11, after all processing personnels have processed the workflow item, “Passed” or “Rejected” will be displayed according to the processing results. After all the processing personnels have completed the triggering operations for the processing controls, the processing controls can be hidden.

In some embodiments of the present disclosure, a current processing status of the workflow item is displayed as a status identification, and the status identification comprises at least one of the following: a first status identification and a second status identification; the first status identification is associated with a name of the workflow item, and the second status identification is associated with the workflow processing interface. In some embodiments, the first status identification may be a text identification or pattern identification near the name of the processing item, such as “Under Approval” in FIG. 7. In some other embodiments, the display pattern of the workflow processing interface may be related to the current processing status of the workflow item. For example, when the workflow item is being processed, the border of the workflow processing interface is displayed as yellow. When the processing of the workflow item is completed and passed, the border is displayed as green. When the processing of the workflow item is completed but rejected, the border of the workflow processing interface is displayed as red, thereby distinguishing the status of the workflow item by the display style.

In some embodiments of the present disclosure, changing a current processing status of a workflow item on the workflow processing interface according to a processing result comprises: changing the first status identification to a first status completion identification, an identification content and an identification style of the first status completion identification being different from an identification content and an identification style of the first status identification. In some embodiments, “Under Approval” shown in FIG. 7 may be the first status identification. After the workflow item is completed, the first status identification will be changed to “Passed” or “Rejected” in FIG. 10 or FIG. 11, which means changing to the first status completion identification, and the display pattern can be changed, such as changing the font color and changing the border color.

In some embodiments of the present disclosure, changing a current processing status of a workflow item on the workflow processing interface according to a processing result comprises: changing the second status identification to a second status completion identification, an identification style of the second status completion identification being different from an identification style of the second status identification. In some embodiments, the second status identification may refer to the border of the workflow processing interface, or the background color or background pattern of the workflow processing interface, etc. The second status completion identification may refer to the border, background color or background pattern of the workflow processing interface after the workflow item has been completed. The second status identification when the workflow item is being processed is different from the second status completion identification when the workflow item is passed or rejected, so that the status of the workflow item can be distinguished.

In some embodiments of the present disclosure, the method further comprises: receiving processing operations of a plurality of the processing personnels on the workflow processing interface, and displaying a processing result of a current processing personnel to other processing personnels on the workflow processing interface, wherein the plurality of processing personnels are processing personnels accessing the first document simultaneously. In some embodiments of the present disclosure, the method proposed by the present disclosure can be applied to collaborative processing scenarios. A plurality of processing personnels can collaboratively process a workflow item in the first document, thereby improving processing efficiency. The workflow processing interface will display the processing results of the processing personnels synchronously.

In some embodiments of the present disclosure, the method further comprises: synchronizing the first document and the workflow item to a workflow application to process the workflow item in the workflow application. In some embodiments of the present disclosure, with reference to FIG. 9, FIG. 9 schematically displays an interface diagram of a workflow application. After creating a processing item, the processing item will be synchronized to the workflow application (such as an approval application). Thus, the processing item may also be viewed in the workflow application, and the processing personnel may view the first document and process the processing item in the workflow application. In some embodiments, further comprising: in response to a first processing for the workflow item in the first document, synchronizing the first processing to a workflow application. In some embodiments, in response to a second processing for the workflow item in the workflow application, synchronize the second processing to the first document. The processing of the processing item in the first document outside the workflow application will be synchronized to the workflow application. Similarly, the processing of the processing item in the workflow application will also be synchronized to the first document, that is, the two remain synchronized. The creator of the workflow item can view the processing receipt of the processing item in the workflow application. The workflow application may be an application for processing various items. Users can view items associated with themselves in the workflow application.

In some embodiments, as shown in FIG. 10, after all processing personnels have processed the workflow item and all agreed to the workflow item, a passed identification will be displayed on the workflow processing interface, configured to identify that the workflow item has been passed. After at least one processing personnel rejects the workflow item, a rejected identification will be displayed on the workflow processing interface.

In the workflow application, the processing status of the first document and the workflow item will be synchronized in real time, and the version when the first document is processed will be saved. In some embodiments, save a version of the first document when the processing personnel processes the workflow item. The first document may be modified during the processing, so it is necessary to save the content of the first document when each processing personnel processes it and view the content of the first document which each processing personnel references while performing processing at any time. In some embodiments, save a version of the first document after the processing personnel completes processing the workflow item.

In some embodiments of the present disclosure, after creating a workflow item associated with the first document, further comprising: sending, in a workflow application, a notification message to the processing personnel using a robot account. In some embodiments, the robot account refers to a system account, which is not an account used by individuals and can be configured to send notification messages. In some embodiments, after creating a workflow item associated with the first document, send, in a workflow application, a notification message to the processing personnel using an account of a creator of the workflow item. By sending a notification message to the processing personnel, the processing personnel can immediately know that the workflow item needs to be processed.

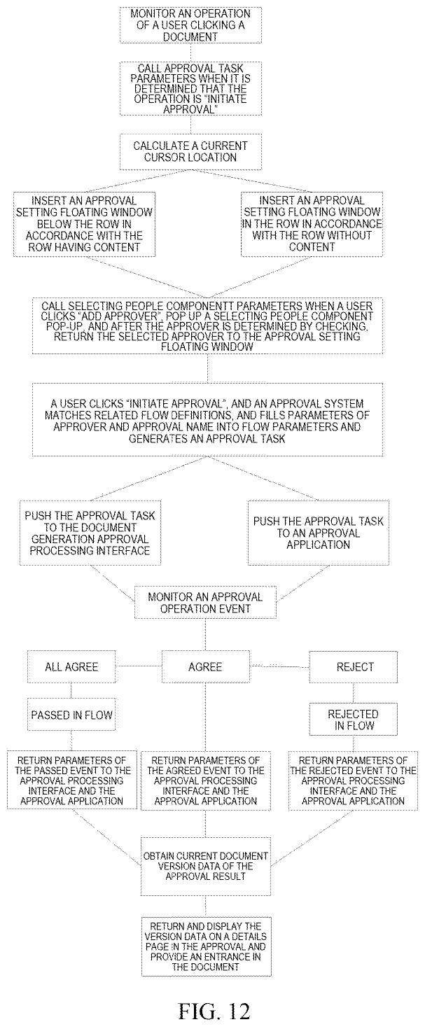

In order to better explain the method according to the embodiment of the present disclosure, a specific embodiment of the present disclosure will be described below in conjunction with FIG. 12. In this embodiment, the workflow item is an approval item. A document editor of the first document may call an option control by clicking the first control in the first document (“+” in FIG. 2) during the process of editing the first document. When it is determined that “Initiate Approval” in FIG. 2 is clicked, approval task parameters are called, and the current cursor location is calculated. If there is no content at the current cursor location, an approval setting floating window is inserted in the row where the current cursor location is, that is, the workflow creation interface where “Initiate Approval” in FIG. 3 is located is created. If there is content at the current cursor location, then the approval setting floating window is inserted in the next row. In the approval setting floating window, the approval name may be set and the approver may be specified. When the user clicks “Add Approver” in FIG. 3, selecting component parameters are called, and a selecting component pop-up window in FIG. 4 pops up. After the approver is confirmed by checking, the user id of the selected approver will be returned to the approval setting floating window. As shown in FIG. 5, “Submit” is clicked to initiate approval. The approval system will help match related procedure definitions of the approval background, and fill in parameters such as the approver ID, initiator ID, and approval name in the procedure parameters to generate an approval task. The approval task will be pushed to the first document, and the workflow processing interface of the approval task shown in FIG. 6 and FIG. 7 will be generated. Moreover, the approval task will also be pushed to the approval application (workflow application), message notifications will be sent to the approvers, and approval operation events of the approvers will be monitored. If the approver passes the approval, the parameters of agreeing the approval workflow will be returned to the workflow processing interface and displayed. For example, as shown in FIG. 7, “Li Yi” has agreed to the approval workflow. If all the approvers agree to the approval workflow, the procedure will pass and the approval operation will be synchronized in the approval application. If one approver rejects the approval task, i.e., overrules the approval task, the approval task will be rejected, i.e., overruled. The version data of the first document at the end of the approval will be saved, displayed on the details page of the approval task in the approval application, and displayed in the first document.

An apparatus for information processing apparatus is further provided in embodiments of the present disclosure, comprising:
A document creation unit for creating a first document;
A display unit for displaying a workflow creation interface in response to receiving a first operation event in the first document;
A workflow creation unit for creating a workflow item associated with the first document in response to a second operation event for the workflow creation interface, wherein the workflow item has an associated processing personnel; and
a control unit for adding a workflow processing interface of the workflow item in the first document;
wherein the workflow processing interface has a processing control for processing the workflow item.

In some embodiments, displaying a workflow creation interface in response to receiving a first operation event in the first document comprises:
Displaying a component panel in response to a first operation for the first document, and displaying a workflow creation interface in response to a triggering operation for a first control in the component panel.

In some embodiments, creating a workflow item associated with the first document in response to a second operation event for the workflow creation interface comprises: determining a processing personnel of the workflow item in response to a second operation for a second control on the workflow creation interface; and creating a workflow item associated with the first document in response to a third operation for a third control on the workflow creation interface.

In some embodiments, the third control is unavailable before determining a processing personnel of the workflow item, or the third control is hidden before determining a processing personnel of the workflow item.

In some embodiments, displaying a workflow creation interface in response to a first operation event comprises: determining a current location of a control identification in the first document in response to a first operation event; in response to that a document context exists at the current location, displaying the workflow creation interface below the current location; and in response to that no document content exists at the current location, displaying the workflow creation interface at the current location.

In some embodiments, displaying a workflow processing interface of the workflow item in the first document comprises: displaying the workflow processing interface at a location of the workflow creation interface after creating a workflow item associated with the first document; or displaying the workflow processing interface in an area corresponding to the workflow creation interface in a page of the first document after creating a workflow item associated with the first document.

In some embodiments, the workflow processing interface further displays at least one of the following: a name of the workflow item, a current processing status of the workflow item, an identification of a processing personnel of the workflow item, a processing result of the processing personnel, a control for adding the processing personnel, and an identification for jumping to the workflow item in a workflow application.

In some embodiments, a display unit is further configured to display a first preset flag at an identification of a processing personnel that has completed the workflow item, and/or a display unit further configured to display a second preset flag at an identification of a processing personnel that has not completed the workflow items.

In some embodiments, a display unit is further configured to display the workflow processing interface when a person associated with the workflow item views the first document; or hide the workflow processing interface when a person not associated with the workflow item views the first document; wherein the person associated with the workflow item comprises a creator and a processing personnel of the workflow item.

In some embodiments, a processing control displayed on the workflow processing interface is related to a role of a person viewing the first document.

In some embodiments, in response to that a person viewing the first document is a creator of the workflow item, the processing control comprises: a control for undoing the workflow item.

In some embodiments, a control unit is further configured to: delete the workflow processing interface in the first document in response to a triggering operation for a control for undoing the workflow item.

In some embodiments, in response to that a person viewing the first document is a processing personnel of the workflow item, the processing control comprises: a control for agreeing to the workflow item and a control for rejecting the workflow item.

In some embodiments, a display unit is further configured to, in response to a triggering operation for a control for agreeing to the workflow item or a control for rejecting the workflow item, display a preset flag corresponding to a triggered control at an identification of a corresponding processing personnel on the workflow processing interface.

In some embodiments, a control unit is further configured to, in response to all processing personnels completing a triggering operation for a processing control, change a current processing status of the workflow item on the workflow processing interface according to a processing result.

In some embodiments, a current processing status of the workflow item is displayed as a status identification, and the status identification comprises at least one of the following: a first status identification and a second status identification; the first status identification is associated with a name of the workflow item, and the second status identification is associated with the workflow processing interface.

In some embodiments, changing a current processing status of a workflow item on the workflow processing interface according to a processing result comprises: changing the first status identification to a first status completion identification, an identification content and an identification style of the first status completion identification being different from an identification content and an identification style of the first status identification; and/or,

Changing the second status identification to a second status completion identification, an identification style of the second status completion identification being different from an identification style of the second status identification.

In some embodiments, a display unit is further configured to: receive processing operations of a plurality of the processing personnels on the workflow processing interface, and display a processing result of a current processing personnel to other processing personnels on the workflow processing interface, wherein the plurality of processing personnels are processing personnels accessing the first document simultaneously.

In some embodiments, a control unit is further configured to: synchronize the first document and the workflow item to a workflow application to process the workflow item in the workflow application.

In some embodiments, a control unit is further configured to: in response to a first processing for the workflow item in the first document, synchronize the first processing to a workflow application; and/or,

In response to a second processing for the workflow item in the workflow application, synchronize the second processing to the first document.

In some embodiments, a control unit is further configured to save a version of the first document when the processing personnel processes the workflow item;

In some embodiments, a control unit is further configured to save a version of the first document after the processing personnel completes processing the workflow item.

In some embodiments, a control unit is further configured to send, in a workflow application, a notification message to the processing personnel using a robot account; or send, in a workflow application, a notification message to the processing personnel using an account of a creator of the workflow item.

As for embodiment of the apparatus, since it basically corresponds to the method embodiment, related parts may refer to the partial description of the method embodiment. The apparatus embodiments described above are only illustrative, where the modules described as separate modules may or may not be separate. Some or all of the modules can be selected according to actual needs to achieve the purpose of the solution of this embodiment. Persons of ordinary skill in the art can understand and implement the method without any creative effort.

The method and apparatus of the present disclosure have been described based on the embodiments and application examples in the foregoing. In addition, the present disclosure also provides an electronic device and a computer-readable storage medium. The electronic device and the computer-readable storage medium will be described below.

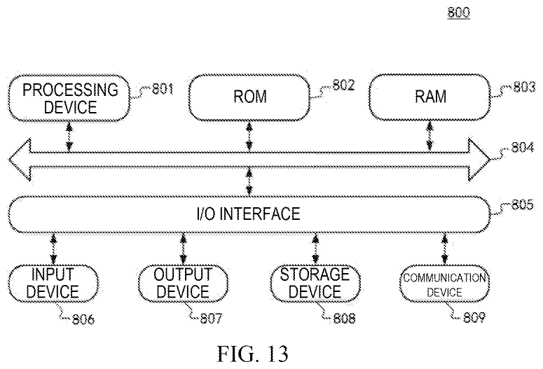

Refer to FIG. 13 in the following, which shows a schematic diagram of an electronic device (a terminal device or a server) 800 according to an embodiment of the present disclosure. Terminal devices in the embodiments of this application may include, but are not limited to, mobile phones, notebook computers, digital broadcast receivers, PDA (Personal Digital Assistant, personal digital assistant), PAD (tablet computer), PMP (Portable Media Player, portable multimedia players), vehicle-mounted terminals (such as vehicle-mounted navigation terminals), etc., as well as fixed terminals such as digital TV (television, television), desktop computers, etc. The electronic device shown in figure is only an example, and should not limit the function and application range of the embodiments of the present disclosure.

The electronic device 800 may include a processing device (such as a central processing unit, a graphics processing unit, or the like) 801 that may perform various appropriate actions and processing according to a program stored in a read-only memory (ROM) 802 or a program loaded from a storage device 808 into a random-access memory (RAM) 803. In the RAM 803, various programs and data required for operation of the electronic device 800 are further stored. The processing device 801, the ROM 802, and the RAM 803 are connected to each other by using a bus 804. An input/output (I/O) interface 805 is also connected to the bus 804.

Generally, the following devices may be connected to the I/O interface 805: input device 806 including, for example, a touchscreen, a touchpad, a keyboard, a mouse, a camera, a microphone, an accelerometer, and a gyroscope; output device 807 including, for example, a liquid crystal display (LCD), a loudspeaker and a vibrator; storage device 808 including, for example, a tape or a hard disk; and a communications device 809. The communications device 809 may allow the electronic device 800 to communicate wirelessly or wiredly with another device to exchange data. Although FIG. 13 shows an electronic device 800 with various devices, it should be understood that it is not required to implement or provide all shown devices. Alternatively, more or fewer devices may be implemented or provided.

In particular, according to the embodiments of the present disclosure, the process described above with reference to the flowchart may be implemented as a computer software program. For example, an embodiment of the present disclosure includes a computer software program product that includes a computer program carried on a readable medium, and the computer program includes program codes used to perform the methods shown in the flowchart. In such an embodiment, the computer program may be downloaded and installed from a network by using the communications device 809, or installed from the storage device 808, or installed from the ROM 802. When the computer program is executed by the processing device 801, the foregoing functions defined in the method in the embodiments of the present disclosure are executed.

It should be noted that the foregoing computer-readable medium in the present disclosure may be a computer-readable signal medium, a computer-readable storage medium, or any combination of the two. The computer-readable storage medium may be, for example, an electrical, magnetic, optical, electromagnetic, infrared, or semiconductor system, apparatus, or means, or any combination thereof. More specific examples of the computer-readable storage medium may include but are not limited to: an electrical connection having one or more conducting wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that includes or stores a program, and the program may be used by or in combination with an instruction execution system, apparatus, or means. In addition, in the present disclosure, the computer-readable signal medium may include a data signal propagated in a baseband or as a part of a carrier, which carries computer-readable program codes. Such a propagated data signal may be in multiple forms, including but not limited to an electromagnetic signal, an optical signal, or any suitable combination thereof. The computer-readable signal medium may further be any computer-readable medium other than the computer-readable storage medium, and the computer-readable signal medium may send, propagate, or transmit a program that is used by or in combination with an instruction execution system, apparatus, or means. The program code included in the computer-readable medium may be transmitted by using any suitable medium, including but not limited to: a wire, an optical cable, RF (radio frequency), or any suitable combination thereof.

In some embodiments, the client and the server can communicate by using any currently known or future-developed network protocol, for example, an HTTP (Hyper Text Transfer Protocol), and can be interconnected by a communication network of any form or any medium. Examples of the communication network include a local area network (“LAN”), a wide area network (“WAN”), an internet network (for example, the Internet), and an end-to-end network (for example, an ad hoc end-to-end network), and any currently known or future-developed network.

The foregoing computer-readable medium may be included in the foregoing electronic device; it may also exist separately without being assembled into the electronic device.

The foregoing computer-readable medium carries one or more programs. When the foregoing one or more programs are executed by the electronic device, so that the electronic device executes the foregoing method of the present disclosure.

Computer program codes for performing the operations of the present disclosure may be written in one or more programming languages or a combination thereof, such as object-oriented programming languages Java, Smalltalk, C++, and conventional procedural programming languages such as “C” or similar program design languages. The program codes may be executed completely on a user computer, partially on a user computer, as an independent package, partially on a user computer and partially on a remote computer, or completely on a remote computer or server. In cases involving a remote computer, the remote computer may be connected to a user computer through any type of network, including a local area network (LAN) or a wide area network (WAN), or may be connected to an external computer (for example, through the Internet by using an Internet service provider).

Flowcharts and block diagrams in the accompanying drawings illustrate possible architectures, functions, and operations of systems, methods, and computer program products according to various embodiments of the present disclosure. In this regard, each block in a flowchart or block diagram may represent a module, program segment, or part of code that includes one or more executable instructions for implementing a specified logical function. It should also be noted that in some alternative implementations, functions marked in the block may also occur in different order than those marked in the accompanying drawings. For example, two blocks represented in succession may actually be executed in substantially parallel, and they may sometimes be executed in a reverse order, depending on the functions involved. It should also be noted that each block in the block diagram and/or flowchart and a combination of blocks in the block diagram and/or flowchart may be implemented by using a dedicated hardware-based system that performs a specified function or operation, or may be implemented by using a combination of dedicated hardware and a computer instruction.

The units described in embodiments of the present disclosure may be implemented either by means of software or by means of hardware. Where, the names of these units do not limit the units themselves under certain circumstances.

The functions described above herein may be performed, at least in part, by one or more hardware logic components. For example, and without limitation, exemplary types of hardware logic components that may be used include: Field Programmable Gate Arrays (FPGAs), Application Specific Integrated Circuits (ASICs), Application Specific Standard Products (ASSPs), Systems on Chips (SOCs), Complex Programmable Logical device (CPLD) and so on.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. Machine-readable media may include, but are not limited to, electronic, magnetic, optical, electromagnetic, infrared, or semiconductor systems, apparatus or device, or any suitable combination of the foregoing. More specific examples of machine-readable storage media would include one or more wire-based electrical connection, portable computer disks, hard disks, random access memory (RAM), read only memory (ROM), erasable programmable read only memory (EPROM or flash memory), optical fiber, portable compact disk read-only memory (CD-ROM), optical storage device, magnetic storage device, or any suitable combination of the foregoing content.

According to one or more embodiments of the present disclosure, a method for information processing is provided, comprising:
Creating a first document;
Displaying a workflow creation interface in response to receiving a first operation event in the first document;
Creating a workflow item associated with the first document in response to a second operation event for the workflow creation interface, wherein the workflow item has an associated processing personnel;
Displaying a workflow processing interface of the workflow item in the first document;
Wherein the workflow processing interface has a processing control for processing the workflow item.

According to one or more embodiments of the present disclosure, a method for information processing is provided, displaying a workflow creation interface in response to receiving a first operation event in the first document comprises:
Displaying a component panel in response to a first operation for the first document, and displaying a workflow creation interface in response to a triggering operation for a first control in the component panel.

According to one or more embodiments of the present disclosure, a method for information processing is provided, creating a workflow item associated with the first document in response to a second operation event for the workflow creation interface comprises:
Determining a processing personnel of the workflow item in response to a second operation for a second control on the workflow creation interface;
Creating a workflow item associated with the first document in response to a third operation for a third control on the workflow creation interface.

According to one or more embodiments of the present disclosure, a method for information processing is provided, the third control is unavailable before determining a processing personnel of the workflow item, or the third control is hidden before determining a processing personnel of the workflow item.

According to one or more embodiments of the present disclosure, a method for information processing is provided, displaying a workflow creation interface in response to a first operation event comprises: determining a current location of a control identification in the first document in response to a first operation event; in response to that a document context exists at the current location, displaying the workflow creation interface below the current location; in response to that no document content exists at the current location, displaying the workflow creation interface at the current location.

According to one or more embodiments of the present disclosure, a method for information processing is provided, displaying a workflow processing interface of the workflow item in the first document comprises:
Displaying the workflow processing interface at a location of the workflow creation interface after creating a workflow item associated with the first document; or
Displaying the workflow processing interface in an area corresponding to the workflow creation interface in a page of the first document after creating a workflow item associated with the first document.

According to one or more embodiments of the present disclosure, a method for information processing is provided, the workflow processing interface further displays at least one of the following: a name of the workflow item, a current processing status of the workflow item, an identification of a processing personnel of the workflow item, a processing result of the processing personnel, a control for adding the processing personnel, and an identification for jumping to the workflow item in a workflow application.

According to one or more embodiments of the present disclosure, a method for information processing is provided, displaying a first preset flag at an identification of a processing personnel that has completed the workflow item; and/or,

Displaying a second preset flag at an identification of a processing personnel that has not completed the workflow items.

According to one or more embodiments of the present disclosure, a method for information processing is provided, displaying the workflow processing interface when a person associated with the workflow item views the first document; or,

Hiding the workflow processing interface when a person not associated with the workflow item views the first document;

Wherein the person associated with the workflow item comprises a creator and a processing personnel of the workflow item.

According to one or more embodiments of the present disclosure, a method for information processing is provided, a processing control displayed on the workflow processing interface is related to a role of a person viewing the first document.

According to one or more embodiments of the present disclosure, a method for information processing is provided, in response to that a person viewing the first document is a creator of the workflow item, the processing control comprises: a control for undoing the workflow item.

According to one or more embodiments of the present disclosure, a method for information processing is provided, further comprising: deleting the workflow processing interface in the first document in response to a triggering operation for a control for undoing the workflow item.

According to one or more embodiments of the present disclosure, a method for information processing is provided, in response to that a person viewing the first document is a processing personnel of the workflow item, the processing control comprises: a control for agreeing to the workflow item and a control for rejecting the workflow item.

According to one or more embodiments of the present disclosure, a method for information processing is provided, further comprising: in response to a triggering operation for a control for agreeing to the workflow item or a control for rejecting the workflow item, displaying a preset flag corresponding to a triggered control at an identification of a corresponding processing personnel on the workflow processing interface.

According to one or more embodiments of the present disclosure, a method for information processing is provided, further comprising: in response to all processing personnels completing a triggering operation for a processing control, changing a current processing status of the workflow item on the workflow processing interface according to a processing result.

According to one or more embodiments of the present disclosure, a method for information processing is provided, a current processing status of the workflow item is displayed as a status identification, and the status identification comprises at least one of the following: a first status identification and a second status identification; the first status identification is associated with a name of the workflow item, and the second status identification is associated with the workflow processing interface.

According to one or more embodiments of the present disclosure, a method for information processing is provided, changing a current processing status of a workflow item on the workflow processing interface according to a processing result comprises:
Changing the first status identification to a first status completion identification, an identification content and an identification style of the first status completion identification being different from an identification content and an identification style of the first status identification; and/or,
Changing the second status identification to a second status completion identification, an identification style of the second status completion identification being different from an identification style of the second status identification.

According to one or more embodiments of the present disclosure, a method for information processing is provided, further comprising:

Receiving processing operations of a plurality of the processing personnels on the workflow processing interface, and displaying a processing result of a current processing personnel to other processing personnels on the workflow processing interface, wherein the plurality of processing personnels are processing personnels accessing the first document simultaneously.

According to one or more embodiments of the present disclosure, a method for information processing is provided, further comprising:

Synchronizing the first document and the workflow item to a workflow application to process the workflow item in the workflow application.

According to one or more embodiments of the present disclosure, a method for information processing is provided, further comprising:
In response to a first processing for the workflow item in the first document, synchronizing the first processing to a workflow application; and/or,
In response to a second processing for the workflow item in the workflow application, synchronizing the second processing to the first document.

According to one or more embodiments of the present disclosure, a method for information processing is provided, further comprising at least one of the following:
Saving a version of the first document when the processing personnel processes the workflow item;
Saving a version of the first document after the processing personnel completes processing the workflow item.

According to one or more embodiments of the present disclosure, a method for information processing is provided, after creating a workflow item associated with the first document, the method further comprising:
Sending, in a workflow application, a notification message to the processing personnel using a robot account;
Or sending, in a workflow application, a notification message to the processing personnel using an account of a creator of the workflow item.

According to one or more embodiments of the present disclosure, an apparatus for information processing is provided, comprising:
A document creation unit for creating a first document;
A display unit for displaying a workflow creation interface in response to receiving a first operation event in the first document;
A workflow creation unit for creating a workflow item associated with the first document in response to a second operation event for the workflow creation interface, wherein the workflow item has an associated processing personnel;
A control unit for adding a workflow processing interface of the workflow item in the first document;
Wherein the workflow processing interface has a processing control for processing the workflow item.

According to one or more embodiments of the present disclosure, an electronic device for information processing is provided, comprising: at least one memory and at least one processor;

Wherein the at least one memory is used to store program code, and the at least one processor is used to call the program code stored in the at least one memory to perform the method of any one of the above.

According to one or more embodiments of the present disclosure, a computer-readable storage medium is provided, the computer-readable storage medium is used to store program code, when the program code is executed by a processor, causes the processor to perform the above method.

The above description is only preferred embodiments of the present disclosure and an illustration of the technical principles utilized. It should be understood by those skilled in the art that the scope of disclosure involved in the present disclosure is not limited to technical solutions formed by a particular combination of the above technical features, but also covers other technical solutions formed by any combination of the above technical features or their equivalent features without departing from the above disclosed concept, for example, a technical solution formed by interchanging the above features with (but not limited to) technical features with similar functions disclosed in the present disclosure.

Furthermore, while the operations are depicted using a particular order, this should not be construed as requiring that the operations be performed in the particular order shown or in sequential order of execution. Multitasking and parallel processing may be advantageous in certain environments. Similarly, while several specific implementation details are included in the above discussion, these should not be construed as limiting the scope of the present disclosure. Certain features described in the context of separate embodiments may also be implemented in combination in a single embodiment. Conversely, various features described in the context of a single embodiment may also be implemented in multiple embodiments, either individually or in any suitable sub-combination.

Although the present subject has been described using language specific to structural features and/or method logical actions, it should be understood that the subject limited in the appended claims is not necessarily limited to the particular features or actions described above. Rather, the particular features and actions described above are merely example forms of implementing the claims.

1. A method for information processing, comprising:
creating a first document;
displaying a workflow creation interface in response to receiving a first operation event in the first document;
creating a workflow item associated with the first document in response to a second operation event for the workflow creation interface, wherein the workflow item has an associated processing personnel; and
displaying a workflow processing interface of the workflow item in the first document;
wherein the workflow processing interface has a processing control for processing the workflow item.

2. The method of claim 1, wherein displaying a workflow creation interface in response to receiving a first operation event in the first document comprises:
displaying a component panel in response to a first operation for the first document, and
displaying a workflow creation interface in response to a triggering operation for a first control in the component panel.

3. The method of claim 1, wherein creating a workflow item associated with the first document in response to a second operation event for the workflow creation interface comprises:
determining a processing personnel of the workflow item in response to a second operation for a second control on the workflow creation interface; and
creating a workflow item associated with the first document in response to a third operation for a third control on the workflow creation interface.

4. The method of claim 3, wherein
the third control is unavailable before determining a processing personnel of the workflow item, or
the third control is hidden before determining a processing personnel of the workflow item.

5. The method of claim 1, wherein displaying a workflow creation interface in response to a first operation event comprises:
determining a current location of a control identification in the first document in response to a first operation event;
in response to that a document context exists at the current location, displaying the workflow creation interface below the current location; and
in response to that no document content exists at the current location, displaying the workflow creation interface at the current location.

6. The method of claim 5, wherein displaying a workflow processing interface of the workflow item in the first document comprises:
displaying the workflow processing interface at a location of the workflow creation interface after creating a workflow item associated with the first document; or
displaying the workflow processing interface in an area corresponding to the workflow creation interface in a page of the first document after creating a workflow item associated with the first document.

7. The method of claim 1, wherein the workflow processing interface further displays at least one of the following: a name of the workflow item, a current processing status of the workflow item, an identification of a processing personnel of the workflow item, a processing result of the processing personnel, a control for adding the processing personnel, and an identification for jumping to the workflow item in a workflow application.

8. The method of claim 7, wherein
displaying a first preset flag at an identification of a processing personnel that has completed the workflow item; and/or
displaying a second preset flag at an identification of a processing personnel that has not completed the workflow items.

9. The method of claim 1, wherein
displaying the workflow processing interface when a person associated with the workflow item views the first document; or
hiding the workflow processing interface when a person not associated with the workflow item views the first document;
wherein the person associated with the workflow item comprises a creator and a processing personnel of the workflow item.

10. The method of claim 1, wherein
a processing control displayed on the workflow processing interface is related to a role of a person viewing the first document; and
in response to that a person viewing the first document is a creator of the workflow item, the processing control comprises: a control for undoing the workflow item.

11. (canceled)

12. The method of claim 10, further comprising: deleting the workflow processing interface in the first document in response to a triggering operation for a control for undoing the workflow item.

13. The method of claim 1, wherein
in response to that a person viewing the first document is a processing personnel of the workflow item, the processing control comprises: a control for agreeing to the workflow item and a control for rejecting the workflow item.

14. The method of claim 13, further comprising: in response to a triggering operation for a control for agreeing to the workflow item or a control for rejecting the workflow item, displaying a preset flag corresponding to a triggered control at an identification of a corresponding processing personnel on the workflow processing interface; and
in response to all processing personnels completing a triggering operation for a processing control, changing a current processing status of the workflow item on the workflow processing interface according to a processing result.

15. (canceled)

16. The method of claim 7, wherein a current processing status of the workflow item is displayed as a status identification, and the status identification comprises at least one of the following: a first status identification and a second status identification; the first status identification is associated with a name of the workflow item, and the second status identification is associated with the workflow processing interface.

17. The method of claim 16, wherein changing a current processing status of a workflow item on the workflow processing interface according to a processing result comprises:
changing the first status identification to a first status completion identification, an identification content and an identification style of the first status completion identification being different from an identification content and an identification style of the first status identification; and/or
changing the second status identification to a second status completion identification, an identification style of the second status completion identification being different from an identification style of the second status identification.

18. The method of claim 1, further comprising:
receiving processing operations of a plurality of the processing personnels on the workflow processing interface;
displaying a processing result of a current processing personnel to other processing personnels on the workflow processing interface, wherein the plurality of processing personnels are processing personnels accessing the first document simultaneously; or
wherein the method further comprises:
synchronizing the first document and the workflow item to a workflow application to process the workflow item in the workflow application; or
wherein the method further comprises:
in response to a first processing for the workflow item in the first document, synchronizing the first processing to a workflow application; and/or
in response to a second processing for the workflow item in the workflow application, synchronizing the second processing to the first document.

19. (canceled)

20. (canceled)

21. The method of claim 1, further comprising at least one of the following:
saving a version of the first document when the processing personnel processes the workflow item; or
saving a version of the first document after the processing personnel completes processing the workflow item.

22. The method of claim 1, wherein after creating a workflow item associated with the first document, the method further comprises:
sending, in a workflow application, a notification message to the processing personnel using a robot account; or
sending, in a workflow application, a notification message to the processing personnel using an account of a creator of the workflow item.

23. (canceled)

24. An electronic device, comprising:
at least one memory and at least one processor;
wherein the at least one memory is used to store program code, and the at least one processor is used to call the program code stored in the at least one memory to perform acts comprising:
creating a first document;
displaying a workflow creation interface in response to receiving a first operation event in the first document;
creating a workflow item associated with the first document in response to a second operation event for the workflow creation interface, wherein the workflow item has an associated processing personnel; and
displaying a workflow processing interface of the workflow item in the first document;
wherein the workflow processing interface has a processing control for processing the workflow item.

25. A non-transitory computer-readable storage medium which is used to store program code, wherein the program code, when the program code is executed by a processor, causes the processor to perform acts comprising:
creating a first document;
displaying a workflow creation interface in response to receiving a first operation event in the first document;
creating a workflow item associated with the first document in response to a second operation event for the workflow creation interface, wherein the workflow item has an associated processing personnel; and
displaying a workflow processing interface of the workflow item in the first document;
wherein the workflow processing interface has a processing control for processing the workflow item.
